(19) United States
(12) Patent Application Publication
(10) Pub. No.: US 2016/0156518 A1
(43) Pub. Date: Jun. 2, 2016

(54) SERVER FOR AUTOMATICALLY SWITCHING SHARING-NETWORK

(71) Applicants: Inventec (Pudong) Technology Corporation, Shanghai (CN); Inventec Corporation, Taipei City (TW)

(72) Inventors: Tianwen ZHAO, Shanghai (CN); Kun LIU, Shanghai (CN); Jian fei LIU, Shanghai (CN)

(21) Appl. No.: 14/603,090

(22) Filed: Jan. 22, 2015

(30) Foreign Application Priority Data
Nov. 27, 2014 (CN) 201410707260.2

(51) Int. Cl. H04L 12/24

(52) U.S. Cl. CPC H04L 41/0853

(57) ABSTRACT

A server for automatically switching sharing-network is disclosed in the present invention. In the server, a plurality of general-network controllers are provided to send a first network-control signal and a network-status signal. A switch module selects one of the first network-control signals as a second network-control signal according to a network-interface-selection signal. The second network-control signal is transmitted to a baseboard management controller (BMC) by the switch module. When a client operates a remote control through the general-network controllers which have sharing-network function, the BMC is received the network-status signals to send the network-interface-selection signal according to a priority list.

### FIELD OF THE INVENTION

The present invention is related to a server for automatically switching sharing-network, and more particularly related to a server for automatically switching sharing-network which automatically switches to the selected general network controller according to a network-interface-selection signal.

### BACKGROUND OF THE INVENTION

With the progress of technology, development of network has lead to a life full of electronic devices. The computing system, such as the server is a fundamental apparatus for establishing a network. In general, the server nowadays has a network management controller, which is the only way for the client to check the system information such as version of firmware, sensed temperature, and etc. If there exists an accident (such as damage on the circuit or slow network speed), the client may want to check the above mentioned system information through the other controllers. However, without the function of sharing-network, these controllers cannot be used to check the system information. Such problem may bother the user, and thus there exists the need to improve the technology in present.

### BRIEF SUMMARY OF INVENTION

Because the controllers of the server in present, except the network management controller, do not have the function of sharing-network, the client would not be able to use these controllers to check the system information which may cause an inconvenience to the user. Accordingly, a server for automatically switching sharing-network is provided in the present invention, which automatically switches from the network management controller to the selected general network controller according to a network-interface-selection signal, such that the above mentioned problem can be resolved.

A server for automatically switching sharing-network is provided in accordance with an embodiment of the present invention. The server comprises a baseboard management controller, a network management controller, a plurality of general network controllers, and a switch module. The baseboard management controller is utilized for managing operating status of the server. The network management controller is coupled to the baseboard management controller, and is utilized for a client to remotely control the baseboard management controller through the network management controller. These general network controllers are coupled to a chipset or a processor for controlling general network transmission and sharing-network. Each of the general network controllers sends a first network control signal and a network status signal. The switch module is electrically connected to the baseboard management controller and the plurality of general network controllers for selecting one of the first network-control signals as a second network-control signal according to a network-interface-selection signal. The second network-control signal is transmitted to the baseboard management controller. Wherein, the client remotely controls the baseboard management controller through the network management controller and one of the general network controllers which has sharing-network function. When a client executes a remote control through the general-network controller which has sharing-network function, the baseboard management controller receives the network status signals to judge status and sends the network-interface-selection signal according to a priority list automatically.

In accordance with an embodiment of the present invention, the switch module is utilized for sending the first network-control signal corresponding to the second network-control signal according to the network-interface-selection signal and the sent first network-control signal is received by the corresponding general network controller. The first network control signals and the second network control signal are utilized for implementing sharing-network function. The first network control signals and the second network control signal are full duplex network controller sideband interface (NCSI) signals. In addition, the server for automatically switching sharing-network further comprises a plurality of network connection ports. Each of the network connection ports is respectively electrically connected to at least one controller selected from a group including the general network controllers and the network management controller. Moreover, when a network connection wire is plugged in the network connection port, the corresponding general network controller generates the network status signal, which may be a network linkup signal.

In accordance with an embodiment of the present invention, the network status signal is a network linkup signal or a network active signal. The switch module is a multiplexer. The network-interface-selection signal is provided from a general purpose I/O (GPIO) of the baseboard management controller. The network management controller is a physical layer (PHY) controller.

By using the server for automatically switching sharing-network provided in the present invention, which has the feature of using the switch module to automatically switch to the general network controllers, the function of sharing-network can be implemented on the existed general network controllers such that the problem of the conventional art can be effectively resolved.

The embodiments adopted in the present invention would be further discussed by using the flowing paragraph and the figures for a better understanding.

### BRIEF DESCRIPTION OF THE DRAWINGS

FIG. 1 is a block diagram showing the server for automatically switching sharing-network in accordance with a preferred embodiment of the present invention.

### DETAILED DESCRIPTION OF THE INVENTION

There are various embodiments of the server for automatically switching sharing-network provided in accordance with the present invention, which are not repeated hereby. Only a preferred embodiment is mentioned in the following paragraph as an example.

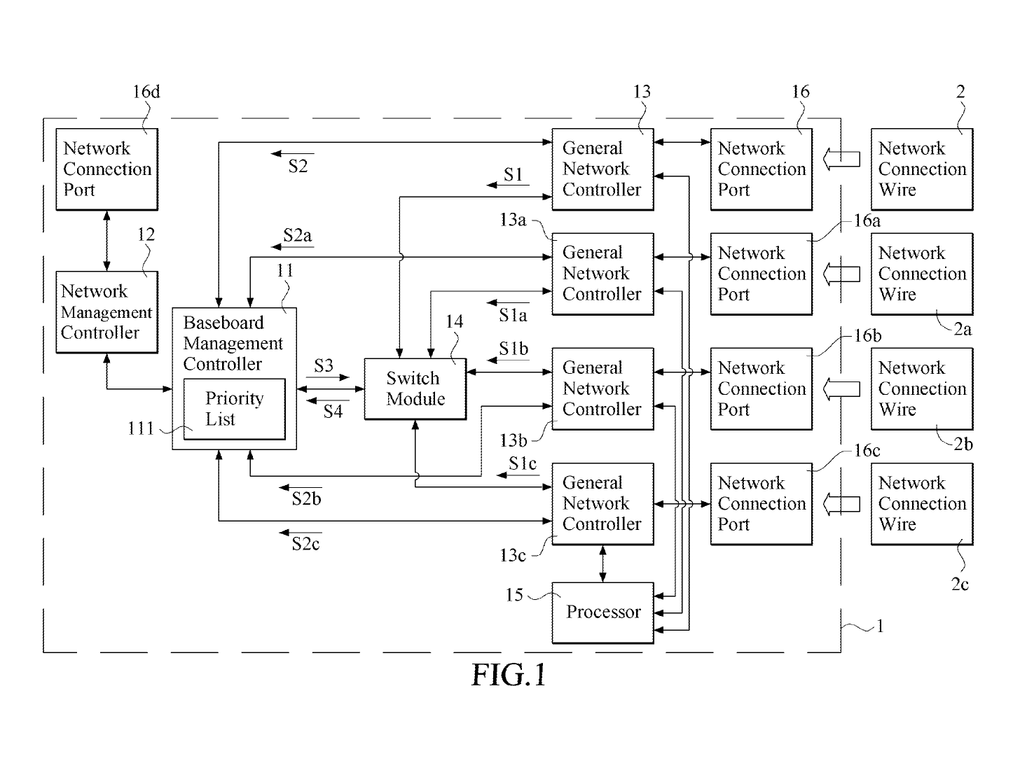

Please refer to FIG. 1, which is a block diagram showing the server for automatically switching sharing-network in accordance with a preferred embodiment of the present invention. As shown, the server 1 for automatically switching sharing-network comprises a baseboard management controller (BMC) 11, a network management controller 12, a plurality of general network controllers 13, 13a, 13b, 13c, a switch module 14, a processor 15, and a plurality of network connection ports 16, 16a, 16b, 16c, 16d.

The baseboard management controller 11 has a priority list 111, which may be related to the relationship of network speed. However, the present invention is not so restricted. The priority list 111 may be stored in a storage unit such as a memory.

The network management controller 12 is coupled to the baseboard management controller 11. The network management controller 12 can be a physical layer (PHY) controller. However, the present invention is not so restricted. The general network controllers 13, 13a, 13b, 13c, are network interface controller (NIC), which are coupled to a processor 15 such as a central processing unit (CPU). In the other embodiments, the processor 15 can be replaced by a chipset, such as the south bridge chip or the north bridge chip. The coupling selection, i.e. the processor 15 or the chipset, depends on the design in practice. In addition, in the present embodiment, the general network controllers 13, 13a, 13b, 13c are also electrically connected to the baseboard management controller 11.

The switch module 14 is electrically connected to the baseboard management controller 11 and those general network controllers 13, 13a, 13b, 13c, and the switch module 14 is a multiplexer. The network connection ports 16, 16a, 16b, 16c, 16d are RJ45 ports or optical fiber connectors. The network connection ports 16, 16a, 16b, 16c, 16d are respectively electrically connected to at least one controller in the group composed of all the general network controllers 13, 13a, 13b, 13c and the network management controller 12. Concretely speaking, as shown in FIG. 1, in accordance with a preferred embodiment of the present invention, the network connection ports 16, 16a, 16b, 16c are respectively electrically connected to the general network controllers 13, 13a, 13b, 13c, and the network connection port 16d is electrically connected to the network management controller 12.

The baseboard management controller 11 is utilized for managing the working states (such as the connection state, the system information checking state) of the server 1. The network management controller 12 allows a client (not shown in this figure, which can be a client's device which electrically connected to the network connection port 16d) remotely controls the baseboard management controller 11 through the network management controller 12 such that the client can check the system information of the server.

The general network controllers 13, 13a, 13b, 13c are utilized for controlling data transmission of general network and providing the capability of sharing-network. Each of the general network controllers 13, 13a, 13b, 13c provides a first network control signal S1, S1a, S1b, S1c and a network status signal S2, S2a, S2b, S2c. Concretely speaking, the network status signal S2, S2a, S2b, S2c can be the network linkup signal (linkup) or the network active signal (active). In accordance with the preferred embodiment of the present invention, as the network connection wires 2, 2a, 2b, 2c are plugged into the network connection ports 16, 16a, 16b, 16c, the corresponding general network controllers 13, 13a, 13b, 13c will generate the corresponding network status signals S2, S2a, S2b, S2c. For example, such network status signal may represent that there has the connection. In addition, the first network control signal S1, S1a, S1b, S1c is the signal transmitted to indicate that the corresponding general network controller 13, 13a, 13b, 13c is used by the client. Such signal would not be transmitted if the corresponding general network controller 13, 13a, 13b, 13c were not used.

The switch module 14 selects one among these first network control signals S1, S1a, S1b, S1c as a second network control signal S4 according to a network-interface-selection signal S3. The second network control signal S4 is transmitted to the baseboard management controller 11. Concretely speaking, the network-interface-selection signal S3 is provided by the general purpose I/O (GPIO) of the baseboard management controller 11. In addition, the switch module 14 is capable to send the one of the first network control signal S1, S1a, S1b, S1c corresponding to the second network control signal S4 according to the network-interface-selection signal S3. The sent first network control signal S1, S1a, S1b, S1c would be received by the corresponding general network controller 13, 13a, 13b, 13c. For example, if the transmitted first network control signal is S1, the corresponding general network controller 13 would be used to receive the first network control signal S1. Thus, the sharing-network function of the general network controllers 13, 13a, 13b, 13c is implemented by the first network control signals S1, S1a, S1b, S1c and the second network control signal S4. The first network control signals S1, S1a, S1b, S1c and the second network control signal S4 are all full duplex network controller sideband interface (NCSI) signals.

Ordinarily, the client can execute remote control for the baseboard management controller 11 through the network management controller 12. However, in accordance with the preferred embodiment of the present invention, the client can also implement remote control for the baseboard management controller 11 with the help of the sharing-network function of the general network controllers 13, 13a, 13b, 13c.

For example, as the client implements remote control with the help of network sharing function of the general network controllers 13, 13a, 13b, 13c and the network connection wires 2, 2a, 2b, 2c are connected to the network connection ports 16, 16a, 16b, 16c respectively, the baseboard management controller 11 receives the network status signal S2, S2a, S2b, S2c to judge the status (i.e. to judge whether there exists the connection) and automatically provides the network-interface-selection signal S3 according to a priority list 111. If the priority list 111 shows the relationship based on network speed (In the other case, the priority list 111 may have a certain general network controller placed in a higher priority) and the network connection port 16 has a faster connection speed, then the baseboard management controller 11 judges that the general network controller 13 should be used to implement remote control. At this time, the first network control signal S1 is used as the second network control signal S4 such that the system information is checked by the client through the general network controller 13. However, if the priority list 111 is set to place the general network controller 13a in a higher priority, then the general network controller 13a would be selected for executing remote control even if the network connection port 16 has a faster connection speed. However, the present invention is not so restricted.

In sum, by using the server for automatically switching sharing-network provided in the present invention, which has the feature of using the switch module to automatically switch to the general network controllers, the function of sharing-network can be implemented by using the existed general network controller such that the problem of the conventional art can be effectively resolved.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A server for automatically switching sharing-network, comprising:
a baseboard management controller, utilized for managing operating status of the server;
a network management controller, coupled to the baseboard management controller, and utilized for a client to remotely control the baseboard management controller through the network management controller;
a plurality of general network controllers, coupled to a chipset or a processor, for controlling general network transmission and sharing-network, and each of the general network controllers sending a first network control signal and a network status signal; and
a switch module, electrically connected to the baseboard management controller and the plurality of general network controllers, for selecting one of the first network-control signals as a second network-control signal according to a network-interface-selection signal, and the second network-control signal being transmitted to the baseboard management controller;
wherein the client remotely controls the baseboard management controller through the network management controller and one of the general network controllers which has sharing-network function;
wherein, when a client operates a remote control through the general-network controller which has sharing-network function, the baseboard management controller receives the network status signals to judge status and sends the network-interface-selection signal according to a priority list automatically.

2. The server for automatically switching sharing-network of claim 1, wherein the switch module is utilized for sending the first network-control signal corresponding to the second network-control signal according to the network-interface-selection signal and the sent first network-control signal is received by the corresponding general network controller.

3. The server for automatically switching sharing-network of claim 1, wherein the first network control signals and the second network control signal are utilized for providing sharing-network function, the first network control signals and the second network control signal are full duplex network controller sideband interface (NCSI) signals.

4. The server for automatically switching sharing-network of claim 1, further comprising a plurality of network connection ports, and each of the network connection ports is respectively electrically connected to at least one controller selected from a group including the general network controllers and the network management controller.

5. The server for automatically switching sharing-network of claim 4, wherein when a network connection wire is plugged in the network connection port, the corresponding general network controller generates the network status signal.

6. The server for automatically switching sharing-network of claim 5, wherein when the network status signal is a network linkup signal.

7. The server for automatically switching sharing-network of claim 1, wherein the network status signal is a network linkup signal or a network active signal.

8. The server for automatically switching sharing-network of claim 1, wherein the switch module is a multiplexer.

9. The server for automatically switching sharing-network of claim 1, wherein the network-interface-selection signal is provided from a general purpose I/O (GPIO) of the baseboard management controller.

10. The server for automatically switching sharing-network of claim 1, wherein the network management controller is a physical layer (PHY) controller.
